(19) United States
(12) Patent Application Publication
(10) Pub. No.: US 2007/0288584 A1
(43) Pub. Date: Dec. 13, 2007

(54) Transition and display system of frame image and cursor and method thereof

(75) Inventors: Chin-Fu Tsai, Taipei (TW); Chien-Chen Lai, Taipei (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 11/607,870

(22) Filed: Dec. 4, 2006

(30) Foreign Application Priority Data
Jun. 12, 2006 (TW) 95120832

(51) Int. Cl. G06F 15/16

(52) U.S. Cl. 709/208; 709/248

(57) ABSTRACT

A transition and display system including a controlled computer and a client computer transmits and displays a frame image and a cursor. The controlled computer includes a frame image capture unit for outputting image data according to primal image data of a primal image and a cursor capture unit for outputting cursor data of the cursor according to the primal image data, wherein the primal image contains the cursor. The client computer receives the frame image data and the cursor data, decodes the frame image data, displays the frame image on the client computer, and laps the cursor over the frame image according to the cursor data.

This application claims the benefit of Taiwan application Serial No. 95120832, filed Jun. 12, 2006, the subject matter of which is incorporated herein by reference.

### BACKGROUND OF THE INVENTION

1. Field of the Invention

The invention relates in general to a transition and display system of a frame image and a cursor, and a method thereof, and more particularly to a transition and display system capable of transmitting image data and cursor data separately to solve the too-low response speed of the cursor upon remote control, and a method thereof.

2. Description of the Related Art

Currently, the remote control software can remotely control a controlled computer through the network. In this case, the position and the image of the cursor are not particularly processed and only the transmitted image of the controlled computer is decoded such that the new position and the new shape of the cursor can be displayed in a client computer. So, when the frame refresh rate or the network bandwidth is too low, the position of the cursor cannot be ensured until the frame is refreshed, thereby causing the user to feel the unsmooth operation of the mouse.

FIG. 1 is a flow chart showing a method of displaying an image and a cursor in a client computer of a conventional computer system. First, in step 101, the client computer receives image data containing the cursor. Then, in step 102, the client computer directly decodes the image data. Finally, in step 103, the client computer displays the decoded image on a display of the client computer. Because the cursor is contained in the image data which is transmitted from a controlled computer to the client computer, the refreshing speed of the cursor is influenced if the speed of transmitting the image data is too slow. Thus, the user cannot move the cursor in the client computer smoothly.

### SUMMARY OF THE INVENTION

It is therefore an object of the invention to provide a transition and display system of a frame image and a cursor, and a method thereof to solve the problem of the too-slow response speed of the cursor when a controlled computer is remotely controlled by a mouse in a client computer.

The invention achieves the above-identified object by providing a transition and display system including a controlled computer and a client computer for transmitting and displaying a frame image and a cursor. The controlled computer includes a frame image capture unit and a cursor capture unit. The frame image capture unit outputs frame image data according to a primal image data of a primal image, wherein the primal image contains the cursor. The cursor capture unit outputs a cursor data of the cursor according to the primal image data. The client computer receives the frame image data and the cursor data, decodes the frame image data to display the frame image on the client computer and laps the cursor over the frame image according to the cursor data.

The invention also achieves the above-identified object by providing a method of transmitting and displaying a frame image and a cursor in a transition and display system. The transition and display system has a controlled computer and a client computer. The method includes the following steps. Firstly, output a frame image data and cursor data of the cursor to the client computer according to a primal image data of a primal image by the controlled computer. The primal image contains the cursor. Then receive the frame image data, decode the frame image data by the client computer and display the frame image on the client computer. Afterward, lap the cursor over the frame image according to the cursor data by the client computer.

Other objects, features, and advantages of the invention will become apparent from the following detailed description of the preferred but non-limiting embodiment. The following description is made with reference to the accompanying drawings.

### BRIEF DESCRIPTION OF THE DRAWINGS

FIG. 1 is a flow chart showing a method of displaying a frame image and a cursor in the conventional remote control technology;

FIG. 2 is a block diagram showing a transition and display system for transmitting and displaying a frame image and a cursor according to the invention;

FIG. 3A is a flow chart showing a method of processing received frame image data in a client computer according to the invention; and

FIG. 3B is a flow chart showing a method of processing received cursor data in the client computer.

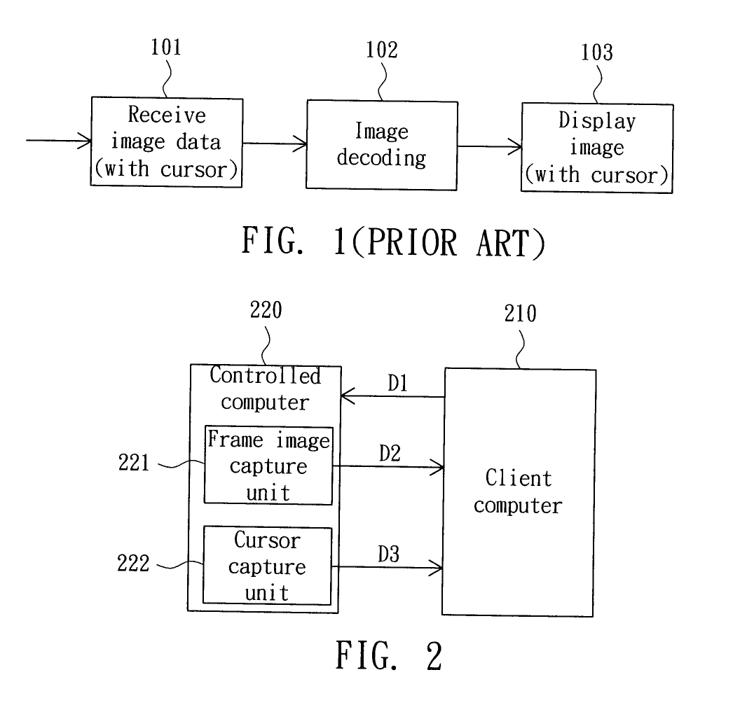

### DETAILED DESCRIPTION OF THE INVENTION

The invention discloses a transition and display system of a frame image and a cursor and a method thereof. The transition and display system has a controlled computer and a client computer. In this transition and display system, the controlled computer decomposes a primal image data into a frame image data and a cursor data, and transmits the frame image data and the cursor data to the client computer, which displays the frame image and the cursor. The primal image data corresponds to a primal image containing the cursor.

FIG. 2 is a block diagram showing a transition and display system for transmitting and displaying a frame image and a cursor according to the invention. Referring to FIG. 2, the transition and display system includes a client computer 210 and a controlled computer 220. The client computer 210 outputs a control signal D1 through a mouse to remotely control the controlled computer 220. The controlled computer 220 includes a frame image capture unit 221 and a cursor capture unit 222. The frame image capture unit 221 outputs a frame image data D2 without the cursor to the client computer 210 according to a primal image data of a primal image containing the cursor. The cursor capture unit 222 outputs a cursor data D3 to the client computer 210 according to the primal image data. The client computer 210 receives the frame image data D2 and the cursor data D3, and then decodes the frame image data to display the frame image without the cursor, and processes the cursor data to lap the cursor corresponding to the cursor data over the frame image.

The transition and display system of this embodiment includes one client computer. In practice, however, the transition and display system of the embodiment according to the present invention may include multiple client computers, each of which remotely controls the controlled computer in the same manner as that mentioned hereinabove.

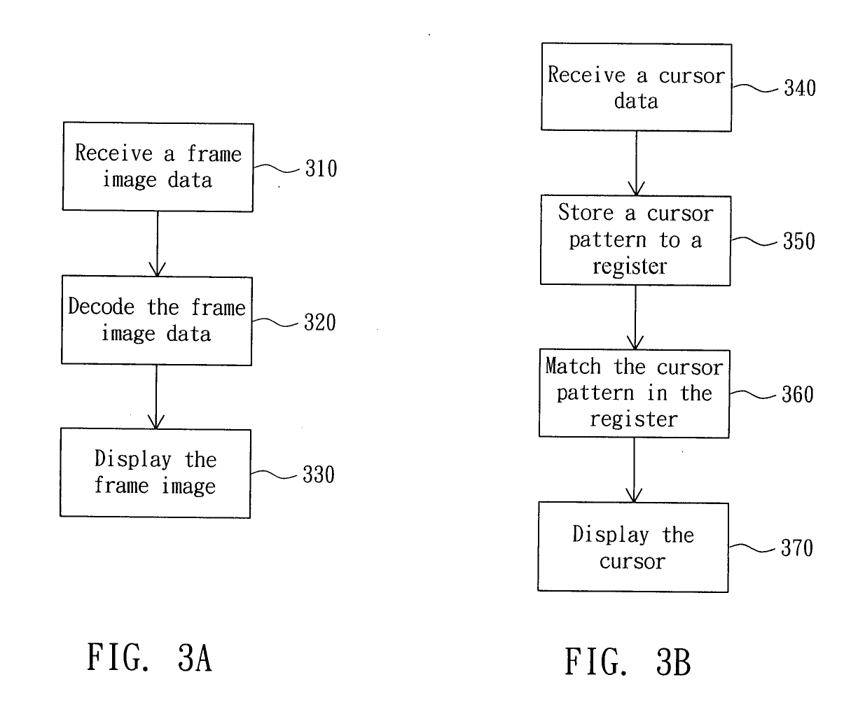

The method of the client computer 210 for processing the received frame image data D2 and cursor data D3 will be described in the following. FIG. 3A is a flow chart showing a method of processing the received frame image data D2 in the client computer 210 according to the invention. In step 310, the client computer 210 receives the frame image data D2 without the cursor. Next, in step 320, the client computer 210 decodes the received frame image data D2. Finally, in step 330, the client computer 210 displays the decoded frame image on the display of the client computer 210.

FIG. 3B is a flow chart showing a method of processing the received cursor data D3 in the client computer 210. In step 340, the client computer 210 receives the cursor data D3, which includes a cursor coordinate, a cursor pattern and a cursor check code. The cursor pattern includes a number. Because the cursor may include multiple cursor patterns, such as an arrow and a finger, the correct pattern has to be found according to the cursor check code. In step 350, the client computer 210 stores the cursor patterns and the numbers into a register. Next, in step 360, the client computer 210 finds the correct cursor pattern by matching the cursor check code with all the numbers of the cursor patterns in the register. Finally, in step 370, the client computer 210 laps the cursor over the frame image of the client computer 210 according to the cursor pattern and the cursor coordinate.

The steps in FIGS. 3A and 3B may be repeatedly performed to refresh the cursor and the frame image. Generally speaking, the frame image data is much larger than the cursor data, so the frequency of performing the cursor processing step of FIG. 3B is higher than the refreshing rate of the frame image in FIG. 3A. Thus, the refreshing rate of the cursor is higher than that of the frame image.

Because the refreshing processes of the cursor and the frame image are not synchronous, directly lapping the cursor over the frame image may cause the new and old cursors to appear on the frame image of the display simultaneously. In order to make sure that the user can always see the newest cursor on the display, the frame image has to be refreshed to clear the old cursor before the cursor is lapped over the frame image.

In the transition and display system of the frame image and the cursor and the method thereof according to the embodiment of the present invention, the cursor data and the frame image data are transmitted separately to independently refresh the cursor data and the frame image data. Because the refresh rate of the cursor is higher than that of the frame image, the cursor can be immediately refreshed when the user is remotely controlling the computer. Thus, the problem of the unsmooth response of the cursor of the mouse in the conventional remote control technology, in which the cursor and the frame image are transmitted simultaneously to the client computer, due to the low refresh rate of the frame image can be avoided.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A transition and display system for transmitting and displaying a frame image and a cursor, the transition and display system comprising:
a controlled computer, which comprises:
an frame image capture unit for outputting a frame image data according to a primal image data of a primal image, the primal image includes the cursor; and
a cursor capture unit for outputting a cursor data of the cursor according to the primal image data; and
a client computer for receiving the frame image data and the cursor data, decoding the frame image data to display the frame image on the client computer, and lapping the cursor over the frame image according to the cursor data.

2. The system according to claim 1, wherein the cursor data comprises:
a cursor coordinate for representing a position of the cursor;
a cursor pattern for representing a display pattern of the cursor, the cursor pattern includes a number; and
a cursor check code, for matching the number of the cursor pattern.

3. The system according to claim 1, wherein the client computer comprises:
a display for displaying the frame image and the cursor; and
a mouse for remotely controlling the cursor of the controlled computer.

4. A method of transmitting and displaying a frame image and a cursor in a transition and display system, the transition and display system having a controlled computer and a client computer, the method comprising the steps of:
outputting a frame image data and a cursor data of the cursor to the client computer according to a primal image data of a primal image by the controlled computer, the primal image contains the cursor;
receiving the frame image data, decoding the frame image data by the client computer and displaying the frame image on the client computer; and
lapping the cursor on the frame image according to the cursor data by the client computer.

5. The method according to claim 4, wherein the cursor data comprises:
a cursor coordinate for representing a position of the cursor;
a cursor pattern for representing a display pattern of the cursor, the cursor pattern includes a number; and
a cursor check code, for matching the number of the cursor pattern.

6. The method according to claim 4, further comprising the steps of:
finding the cursor pattern by matching according to the cursor check code; and
lapping the cursor over the frame image according to the cursor coordinate and the cursor pattern.
